(19) United States
(12) Patent Application Publication
(10) Pub. No.: US 2008/0194785 A1
(43) Pub. Date: Aug. 14, 2008

(54) Composition Containing Polyamino-Polysiloxane And/Or Polyammonium-Polysiloxane Compounds On A Substrate

(75) Inventors: Roland Wagner, Siegburg (DE); Sabine Nienstedt, Bonn (DE); Christopher Roos, Koln (DE); Annette Moeller, Leverkusen (DE); Karl-Heinz Sockel, Leverkusen (DE); Karl-Heinz Stachulla, Leverkusen (DE); Anita Witossek, Langenfeld (DE); Horst Lange, Boghum (DE)

Correspondence Address: RANKIN, HILL & CLARK LLP, 925 EUCLID AVENUE, SUITE 700, CLEVELAND, OH, 44115-1405, US

(73) Assignee: MOMENTIVE PERFORMANCE MATERIALS GMBH, Leverkusen (DE)

(21) Appl. No.: 11/909,621

(22) PCT Filed: Mar. 30, 2006
(86) PCT No.: PCT/EP2006/002911

§ 371 Date: Jan. 11, 2008

(30) Foreign Application Priority Data
Mar. 30, 2005 (DE) 102005014312.1

(51) Int. Cl. C08G 77/14

(52) U.S. Cl. 528/27; 528/28

(57) ABSTRACT

The invention concerns compositions comprising a composition containing a polyamino-polysiloxane and/or polyammonium-polysiloxane compound on a substrate. The invention also concerns methods for producing said compounds as well as their use for treating wet textiles after washing.

The invention relates to compositions which comprise at least one polyamino- and/or polyammonium-polysiloxane compound on a substrate, to processes for their production and to their use for textile treatment, especially for treatment of moist textiles after washing.

U.S. Pat. No. 3,442,692 discloses a process for conditioning laundry, in which moist items of laundry are mixed together with a substrate comprising a conditioning composition in a laundry dryer under the action of heat with movement, which transfers the conditioning composition to the items of laundry during the drying. The conditioning compositions used are, for example, softeners and antistats, bacteriostats, antifungal and antimoth compositions. The softeners and antistats mentioned are generally cationic compounds, such as ammonium compounds.

However, the ammonium compounds mentioned are disadvantageous, since they generally do not have sufficient substantivity, i.e. their ability to attach to the fiber during a customary laundry drying operation in a lasting manner is low. The attempt to improve the substantivity, for example by an increase in the content of ammonium groups, is generally accompanied by a deterioration in the softening properties.

Moreover, relatively high amounts of the conditioners are required, since the conditioners, under the conditions of the laundry drying, are constantly being detached from the items of laundry and pass into the environment by means of the dryer air outlet.

There is therefore an urgent need to improve the substrate-based conditioners from the prior art with regard to substantivity and softening properties and hence to improve the activity and the effectiveness of the substrate-based conditioners.

It has been found that, surprisingly, compositions which comprise a substrate and at least one polyamino- and/or polyammonium-polysiloxane compound which has been applied to the substrate are capable of solving the objective described above.

The polyamino- and/or polyammonium-polysiloxane compounds used in accordance with the invention are characterized in that they comprise an average of at least one organopolysiloxane group and at least one amino and/or ammonium group. The polyamino- and/or polyammonium-polysiloxane compounds preferably contain an average of at least two, even more preferably at least three, organopolysiloxane groups and at least two, preferably at least three, amino and/or ammonium groups. An organopolysiloxane group in the context of the invention is a group which has at least two silicon atoms bonded via an oxygen atom, at least one of the silicon atoms having at least one organic radical bonded via a carbon atom.

In a preferred embodiment of the invention, the polyamino- and/or polyammonium-polysiloxane compounds are selected from polyamino- and/or polyammonium-polysiloxane copolymer compounds. Such copolymer compounds are characterized by a content of linear molecule sections with alternating organopolysiloxane groups and amino and/or ammonium groups. This does not rule out that the copolymer compound may be branched.

In a preferred embodiment of the invention, the polyamino- and/or polyammonium-polysiloxane copolymer compounds are characterized in that they have at least one repeat unit, preferably an average of at least two repeat units, even more preferably an average of at least three repeat units, of the formula (I):

-[Q-V]— (I)

in which Q is selected from the group which consists of:

—NR—,

—N⁺R₂—,

a saturated or unsaturated diamino-functional heterocycle of the formulae:

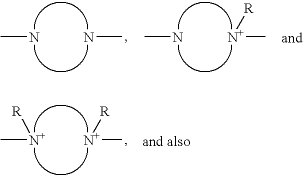

an aromatic diamino-functional heterocycle of the formula:

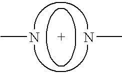

a trivalent radical of the formula:

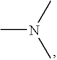

a trivalent radical of the formula:

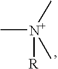

or
a tetravalent radical of the formula

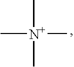

in which R is in each case hydrogen or a monovalent organic radical,
where Q is not bonded to a carbonyl carbon atom,
V is selected from the group which consists of V¹, V² and V³, in which
V² is selected from divalent straight-chain, cyclic or branched, saturated, unsaturated or aromatic hydrocarbon radicals which have up to 1000 carbon atoms (not counting the carbon atoms of the polysiloxane radical Z² defined below) and may optionally contain one or more groups selected from
—O—, —CONH—,

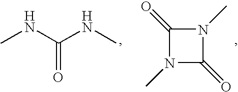

—CONR²— in which R² is hydrogen, a monovalent straight-chain, cyclic or branched, saturated, unsaturated or aromatic hydrocarbon radical which has up to 100 carbon atoms, may contain one or more groups selected from —O—, —NH—, —C(O)— and —C(S)— and may optionally be substituted by one or more substituents selected from the group which consists of a hydroxyl group, an optionally substituted heterocyclic group preferably containing one or more nitrogen atoms, amino, alkylamino, dialkylamino, ammonium, polyether radicals and polyether ester radicals, where, when a plurality of —CONR² groups are present, they may be the same or different,
—C(O)— and —C(S)—,
the V² radical may optionally be substituted by one or more hydroxyl groups and/or by

—Si(OR)₃₋ₐ(R′)ₐ
in which a is an integer from 0 to 2 and R and R′ may be the same or different and are each an organic radical, and
   the V² radical contains at least one -Z²- group of the formula

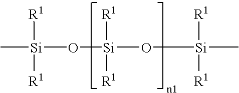

in which
R¹ may be the same or different and is selected from the group which consists of: C₁-C₂₂-alkyl, fluoro(C₁-C₁₀)alkyl, C₆-C₁₀-aryl and —W—Si(OR)₃₋ₐ(R′)ₐ in which R, R′ and a are each as defined above and W is —O— or a divalent straight-chain, cyclic or branched, saturated, unsaturated or aromatic hydrocarbon radical which has up to 100 carbon atoms, may contain one or more —C(O)—, —O—, —NH—, —S— groups and may optionally be substituted by hydroxyl groups, and
n₁=from 20 to 1000,
V¹ is selected from divalent straight-chain, cyclic or branched, saturated, unsaturated or aromatic hydrocarbon radicals which have up to 1000 carbon atoms and may optionally contain one or more groups selected from
—O—, —CONH—,

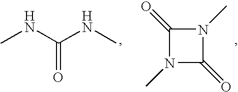

—CONR²— in which R² is as defined above, where the R² groups in the V¹ and V² groups may be the same or different,
—C(O)—, —C(S)— and -Z¹- in which -Z¹- is a group of the formula

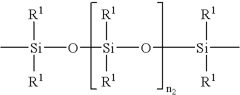

in which
R¹ is as defined above, where the R¹ groups in the V¹ and V² groups may be the same or different, and
n₂=from 0 to 19,
and the V¹ radical may optionally be substituted by one or more hydroxyl groups and/or by

—Si(OR)₃₋ₐ(R′)ₐ
in which a is an integer from 0 to 2 and R and R′ may be the same or different and are each an organic radical, and
   V³ is a trivalent or higher-valency straight-chain, cyclic or branched, saturated, unsaturated or aromatic hydrocarbon radical which has up to 1000 carbon atoms and may optionally contain one or more groups selected from
—O—, —CONH—,

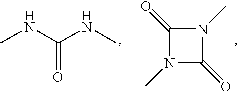

—CONR²— in which R² is as defined above, —C(O)—, —C(S)—, -Z¹- which is as defined above, -Z²- which is as defined above, and Z³ in which Z³ is a trivalent or higher-valency organopolysiloxane unit, and
   which may optionally be substituted by one or more hydroxyl groups and/or by

—Si(OR)₃₋ₐ(R′)ₐ

in which a is an integer from 0 to 2 and R and R′ may be the same or different and are each an organic radical,
with the proviso
that the polysiloxane compound mentioned contains at least one -Z¹-, -Z²- or Z³ group,
that the trivalent and tetravalent Q radicals either serve to branch the main chain formed from Q and V, such that the valencies which do not serve for bonding in the main chain bear further branches formed from -[Q-V]— units, or the trivalent and tetravalent Q radicals are saturated by V³ radicals within a linear main chain without formation of a branch,
   and in which the positive charges which result from ammonium groups are neutralized by organic or inorganic acid anions. These copolymer compounds have a particularly high substantivity with simultaneously high softener action.

In a particularly preferred embodiment of the invention, the substituents R in the Q groups comprise one or more R^{O} radicals where R^{O} is a polyalkylene oxide-containing organic radical. The use of these R^{O} radicals leads to enhanced hydrophilicity of the polyamino- and/or polyammonium-polysiloxane copolymer compounds, which thus become attached more rapidly to the moist items of laundry originating from the textile washing operation.

In a preferred embodiment, the inventive polyamino- and/or polyammonium-polysiloxane copolymer compounds are characterized in that the molar R^{O}:Q ratio is from 0.001 to 2, more preferably from 0.01 to 1, more preferably from 0.05 to 0.8. When the molar ratio is less than 0.001, the hydrophilicity is too low. An optimal balance of softness and hydrophilicity is possible in the range from 0.05 to 0.8.

The R^{O} radical is preferably a group of the formula (III):

—X-E-Y (III)

in which X is a single bond or a divalent straight-chain, branched or cyclic hydrocarbon radical which has up to 20 carbon atoms and may optionally contain nitrogen and/or oxygen, and X is bonded to the nitrogen atom of Q via a carbon atom,
E is a polyalkylene oxide radical of the formula

—[(CₐH₂ₐ)O]_{y}

in which a=from 2 to 4, and
y=from 2 to 10 000,
which is bonded to the X group via a carbon atom and to the Y group via an oxygen atom,
Y is hydrogen or a monovalent straight-chain, branched or cyclic, saturated, unsaturated or aromatic hydrocarbon radical which has up to 24 carbon atoms, may contain oxygen and/or nitrogen and/or halogen and is bonded to the E group via a carbon atom.

R^{O} is preferably a group of the formula (III) in which -E- is a group of the formula (IV):

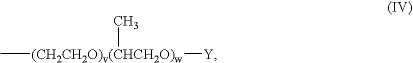

which may represent random and blockwise sequences of the ethylene oxide and propylene oxide units, and the bond to E may be via an ethylene oxide or propylene oxide unit, the representation of the (IV) group therefore being only quantitative,

where

v=from 0 to 200,

w=from 0 to 200,

v+w≧1.

In the group of the formula (III), moreover, Y is preferably selected from H or straight-chain, cyclic, branched C₁-C₂₂-alkyl, -alkenyl, -alkynyl, fluoro(C₁-C₁₀)alkyl and C₆-C₁₀-aryl radicals.

Further preferred alkylene oxide units R^{O} preferably have the structure:

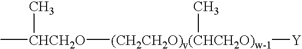

where
v=from 0 to 200,
w=from 0 to 200,
v+w≧1
Y=H or straight-chain, cyclic, branched C₁-C₂₂-alkyl, -alkenyl, -alkynyl, fluoro(C₁-C₁₀)alkyl and C₆-C₁₀-aryl radical.

Preferably, in the above general polyalkylene oxide formulae:

v is from 0 to 100, more preferably from 0 to 70, especially from 0 to 40, very especially from 0 to 20,
w is from 0 to 100, more preferably from 0 to 70, especially from 0 to 40, very especially from 0 to 20,
Y is a straight-chain, cyclic, branched C₁-C₁₂-alkyl, -alkenyl, -alkynyl, or C₆-C₁₀-aryl radical, especially methyl, ethyl, isopropyl, butyl, hexyl, dodecyl, allyl, oleyl, phenyl.

A further preferred alkylene oxide unit R^{O} has the structure

—(C₁-C₁₂)alkylene-N⁺R₂EY

in which C1-C12-alkylene is a straight-chain, cyclic or branched alkylene unit having from 1 to 12 carbon atoms, and R, E and Y are each as defined above.

The polysiloxane compounds which contain an average of preferably at least two, preferably at least three, more preferably at least four, units of the formula (I), preferably an average of at least two, more preferably at least three, even more preferably at least four, R^{O} units being present, and an average of at least one V¹, V² and/or V³ unit preferably being present, are preferably terminated by monofunctional -Q-R and/or —V—R groups, i.e., for example, by amino groups. These arise through saturation of one of the two bonding sites of Q or V by a monovalent R group or hydrogen, each of which is as defined above, and are also referred to hereinafter as V^{st} or Q^{st}. Other unconverted reactive groups, such as epoxy or haloalkyl groups, may also be in place of V^{st}.

The inventive polysiloxane compounds which contain an average of preferably at least two units of the formula (I), where an average of at least two R^{O} units may preferably be present, and an average of at least one V¹, V² and/or V³ unit is preferably present, are, for example, linear polysiloxane copolymers of the general formula (I′):

-[Q-V]— (I′)

in which Q is as defined above, and
V and is at least one V¹ group or V² group,
in which V¹ and V² are each as defined above. In addition, V may also be trivalent or higher-valency, particularly trivalent, V³ radicals. In this case, preferably also trivalent or tetravalent Q units as defined above are present, and the trivalent or higher-valency V³ radicals and the trivalent or tetravalent Q units are saturated preferably exclusively among one another within the linear main chain to form cyclic structures, as explained in detail below. However, this case is less preferred.

In the general formulae (I) or (I′), the molar ratio of the V¹ and V² groups in the polysiloxane compounds V²/V¹ may assume any value per se. The invention thus also includes the case in which the polysiloxane compound of the formula (I) or (I′) contains only V² units, i.e. the polysiloxane compound has the formula -[Q-V²]—. The case in which the polysiloxane compound contains only V¹ units is also included in the invention. In this case, the V¹ units must, however, contain Z¹-siloxane units.

In a preferred embodiment of the invention, the polysiloxane compound of the formula (I) or (I′), however, contains both V² and V¹ units.

In a further preferred embodiment of the present invention, the molar ratio of the V¹ and V² groups in the polysiloxane compounds of the general formula (I) or (I′) is:

V²/V¹=1.

In a further embodiment of the linear polysiloxane compounds of the formula (I) or (I′), V²/V¹ is unequal to 1; V²/V¹ is preferably <1, preferably <0.9; even more preferably, V²/V¹ satisfies the relationship

0.0005<V²/V¹<0.5,

even more preferably

0.0005<V²/V¹<0.3.

The R group is preferably selected from the R² groups.

Preferred embodiments of Q are:

For radicals of the formula

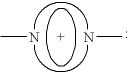

a quaternized imidazole unit of the structure

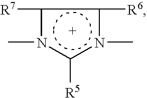

a quaternized pyrazole unit of the structure

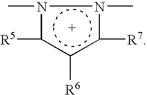

For radicals of the formula

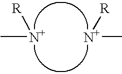

a diquaternized piperazine unit of the structure

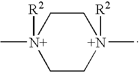

For radicals of the formula

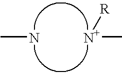

a monoquaternized piperazine unit of the structure

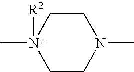

and
a monoquaternized piperazine unit of the structure

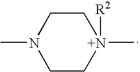

For radicals of the formula

—N⁺R₂—

a diquaternized unit of the structure

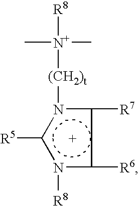

a monoquaternized unit of the structure

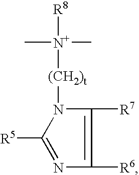

a diquaternized unit of the structure

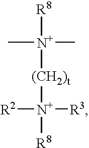

and a monoquaternized unit of the structure

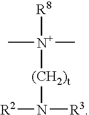

For radicals of the formula

—NR—

a monoquaternized unit of the structure

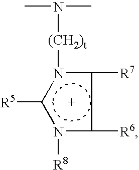

a monoquaternized unit of the structure

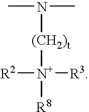

In which:

t is from 2 to 10,
R is as defined above, preferably R², R² is as defined above, and the definition of R² may be the same as or different from the definition of the above R² group,
R³ is as defined for R², where R² and R³ may be the same or different, or
R² and R³, together with the positively charged nitrogen atom, form a five- to seven-membered heterocycle which may optionally additionally have one or more nitrogen, oxygen and/or sulfur atoms,
R⁵, R⁶, R⁷ may be the same or different and are selected from the group which consists of: H, halogen, hydroxyl group, nitro group, cyano group, thiol group, carboxyl group, alkyl group, monohydroxyalkyl group, polyhydroxyalkyl group, thioalkyl group, cyanoalkyl group, alkoxy group, acyl group, acetyloxy group, cycloalkyl group, aryl group, alkylaryl group, and groups of the —NHR^{W} type in which R^{W} is H, alkyl group, monohydroxyalkyl group, polyhydroxyalkyl group, acetyl group, ureido group, and in each case two of the adjacent R⁵, R⁶ and R⁷ radicals with the carbon atoms which bond them to the heterocycle may form aromatic five- to seven-membered rings, and
R⁸ is as defined for R², where R⁸ and R² may be the same or different. In particular, R⁸ may be a polyoxyalkylene-containing radical, which leads to the formation of an R^{O}-containing Q radical.

In the case that Q is a trivalent radical of the formulae

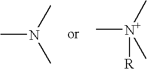

or a tetravalent radical

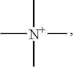

these radicals in the linear copolymers of the formula (I′), as mentioned above, preferably do not serve to branch the polysiloxane copolymers, but rather these radicals are bonded exclusively to especially trivalent V³ radicals to form cyclic structures which are part of the linear main chain, for example a structural element of the formula:

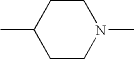

In a preferred embodiment of the polysiloxane compounds of the formula (I) or (I′), V² is a group of the formula

—V²*-Z²-V²*—

in which Z² is as defined above and V²* is a divalent straight-chain, cyclic or branched, saturated, unsaturated or aromatic hydrocarbon radical which has up to 40 carbon atoms and may optionally contain one or more groups selected from —O—, —CONH—, —CONR²— in which R² is as defined above, —C(O)— and —C(S)—, and the V²* radical may optionally be substituted by one or more hydroxyl groups.

In the aforementioned embodiment, the inventive linear polysiloxane copolymer may have the following repeat units:

—[V²*-Z²-V²*-Q]-, preferably together with —[V¹-Q]-.

The molar ratio of the repeat units [V²*-Z²-V²*-Q]- to —[V¹-Q]-, i.e. the V²/V¹ ratio, as mentioned above, may be about 1, but in one embodiment is preferably unequal to 1, more preferably >1, even more preferably >1 and less than 1.5. The introduction of hydrophilic side groups R^{O} in a comblike manner enables the proportion of the V² group which contributes the softening properties to be increased with equal hydrophilicity. Conversely, for a given proportion of softening V² groups, it is possible to increase the hydrophilicity by introducing the R^{O} group.

As will be explained in detail below in connection with the process for preparing the above-described linear polysiloxane copolymers, the blockwise sequences which have more than one —[V¹-Q]- unit bonded to one another, according to the preparation method, may be bonded regularly to the V²-Q units or irregularly to the V²-Q units. This means the following:

In the regular compound in which, for example, a prepolymer corresponding to the -Q-[V¹-Q]ₓ group is reacted with monomer units corresponding to V² in a molar ratio of 1:1, the linear polysiloxane copolymers can be prepared as follows:

—{V²-Q-[V¹-Q]ₓ—}_{y}—.

x may be from 2 to 2000 and is the mean value of the distribution, and y is likewise a mean value and is from 2 to 1000.

In general, the inventive polysiloxane polymers therefore preferably have the formula in which y′ is from 2 to 1000, more preferably from 3 to 500, even more preferably from 4 to 200.

The linear polysiloxane copolymers represented by the formula —{V²-Q-[V¹-Q]ₓ—}_{y}— are characterized in that they essentially have no —V²-Q units bonded to one another, or, in other words, two —V¹-Q- units are always interrupted by at least one —V¹-Q unit.

In the irregular compound in which, for example, monomers corresponding to Q units are reacted with monomer units corresponding to V¹ and monomer units corresponding to V² in a ratio of Q/(V¹+V²) where, for example, V²/V¹>1, the linear polysiloxane copolymers can be represented as follows:

-Q-(V¹,V²)—

in which V the V²/V¹ ratio is then >1. In this case, the V¹ and V² groups are distributed randomly through the copolymer chain. In contrast to the linear polysiloxane copolymers prepared by the regular compound, this copolymer may also have adjacent -Q-V²- units.

In a preferred embodiment of the polysiloxane compound of the formula (I) or (I′) used in accordance with the invention, the V¹ group is selected from divalent straight-chain, cyclic or branched, saturated, unsaturated or aromatic hydrocarbon radicals which have up to 600, preferably up to 400, carbon atoms and optionally contain one or more groups selected from —O—, —CONH—,

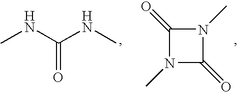

—CONR²— in which R² is as defined above, —C(O)—, —C(S)— and -Z¹- in which -Z¹- is a group of the formula

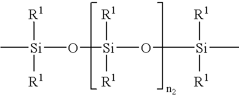

in which
R¹ is C₁-C₁₈-alkyl which may optionally be substituted by one or more fluorine atoms, or phenyl, and n₂ is as defined above.

In a further preferred embodiment of the polysiloxane compounds of the formula (I) or (I′), the Q group is selected from:

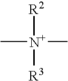

in which R² is preferably H or alkyl, preferably having from 1 to 6 carbon atoms, and R³ is preferably H, alkyl, preferably having from 1 to 6 carbon atoms, or R^{O}.

Preferably, in the formulae (I) and (I′):

R¹=C₁-C₁₈-alkyl, especially methyl, ethyl, trifluoropropyl and phenyl,
n₁=from 20 to 400, more preferably from 20 to 300, especially from 20 to 200. In a further preferred embodiment, n₁ is between 20 and 50 or between 80 and 200. The number n₁ is the mean degree of polymerization from Mₙ of the diorganosiloxy units in the Z² group.

n₂=from 0 to 15, more preferably from 0 to 10, especially from 0 to 5, more especially 0. The number n₂ is the mean degree of polymerization from Mₙ of the diorganosiloxy units in the Z¹ group.

More preferably,

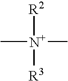

### is —NH₂⁺—, —N(CH₃)₂^{+—, —(NHR}^{O})⁺—.

V²* is a divalent straight-chain, cyclic or branched, saturated, unsaturated or aromatic hydrocarbon radical which has up to 16 carbon atoms, may contain one or more groups selected from —O—, —CONH—, —CONR²— in which R² is as defined above, —C(O)—, —C(S)— and may be substituted by one or more hydroxyl groups. Even more preferably, —V²* is selected from groups of the formulae:

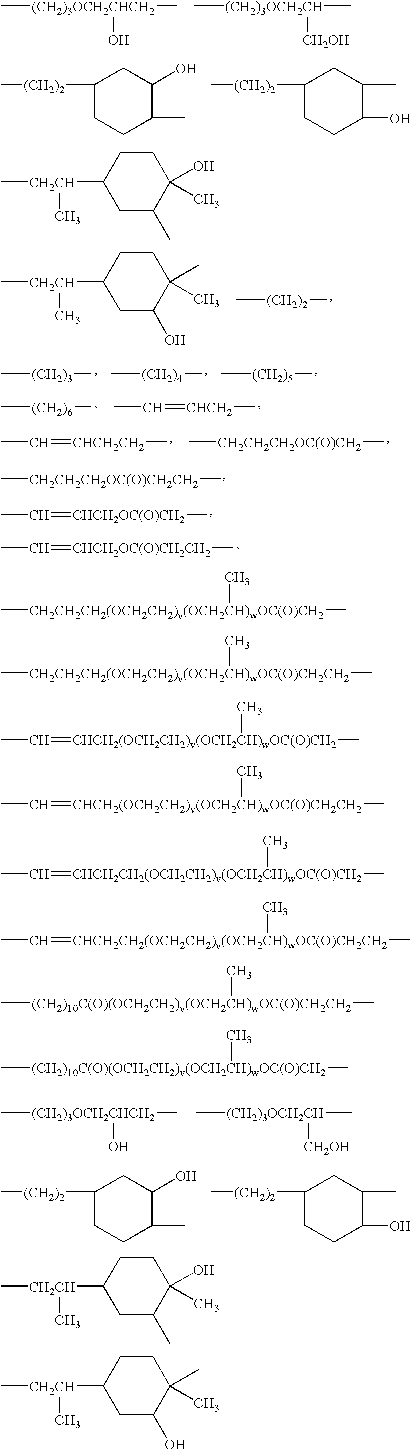

with v+w≧0,
—(CH₂)₃—, —(CH₂)₄—, —(CH₂)₅—, —(CH₂)₆—, —CH═CHCH₂—, —CH═CHCH₂CH₂—, —CH₂CH₂CH₂OC(O)C₂—, —CH₂CH₂CH₂OC(O)CH₂CH₂—.

V¹ is preferably
—R⁹— in which R⁹ is a divalent saturated or mono- or polyunsaturated, straight-chain or branched hydrocarbon radical having from two to 25 carbon atoms,
—(CH₂)ᵤC(O)O—[(CH₂CH₂O)_{q}—(CH₂CH(CH₃)O)ᵣ]—C(O)(CH₂)ᵤ—
—(CH₂)ᵤC(O)O—R⁹—O—C(O)(CH₂)ᵤ—, in which R⁹ is as defined above,
—(CH₂)ᵤ—R¹⁰—(CH₂)ᵤ—, in which R¹⁰ is an aromatic group,
—[CH₂CH₂O]_{q}—[CH₂CH(CH₃)O]ᵣ—CH₂CH₂—,
—CH(CH₃)CH₂O[CH₂CH₂O]_{q}—[CH₂CH(CH₃)O]ᵣ—CH₂CH(CH₃)—
—CH₂CH(OH)CH₂—,
—CH₂CH(OH)(CH₂)₂CH(OH)CH₂—,
—CH₂CH(OH)CH₂OCH₂CH(OH)CH₂OCH₂CH(OH)CH₂— and
—CH₂CH(OH)CH₂O—[CH₂CH₂O]_{q}—[CH₂CH(CH₃)O]ᵣ—CH₂CH(OH)CH₂—
   in which
   u is from 1 to 3,
   q and r are from 0 to 200, preferably from 0 to 100, more preferably from 0 to 70 and especially preferably from 0 to 40, and
   q+r>0.

Preferred variants of V¹ are structures of the formula:

—CH₂C(O)O—[CH₂CH₂O]_{q}—[CH₂CH(CH₃)O]ᵣ—C(O)CH₂—,
—CH₂CH₂C(O)O—[CH₂CH₂O]_{q}—[CH₂CH(CH₃)O]ᵣC(O)CH₂CH₂—,
—CH₂CH₂CH₂C(O)O—[CH₂CH₂O]_{q}—[CH₂CH(CH₃)O]ᵣC(O)CH₂CH₂CH₂—,
esterified alkylene, alkenylene, alkynylene units, especially of the structures
—CH₂C(O)O—[CH₂]ₒ—OC(O)CH₂—,
—CH₂CH₂C(O)O—[CH₂]ₒ—OC(O)CH₂CH₂—,
—CH₂CH₂CH₂C(O)O—[CH₂]ₒ—OC(O)CH₂CH₂CH₂

### —CH₂C(O)O—CH₂C≡CCH₂—OC(O)CH₂—,

### —CH₂CH₂C(O)O—CH₂C≡CCH₂—OC(O)CH₂CH₂—,

### —CH₂CH₂CH₂C(O)O—CH₂C≡CCH₂—OC(O)CH₂CH₂CH₂—,

### —CH₂C(O)O—CH₂CH═CHCH₂—OC(O)CH₂—,

### —CH₂CH₂C(O)O—CH₂CH═CHCH₂—OC(O)CH₂CH₂—,

### —CH₂CH₂CH₂C(O)O—CH₂CH═CHCH₂—OC(O)CH₂CH₂CH₂—,

alkylene, alkenylene, alkynylene and aryl units, especially of the structures:
—[CH₂]ₒ—
where o=from 2 to 6,
in which a, b and c are the same or different and may be from 1 to 40,

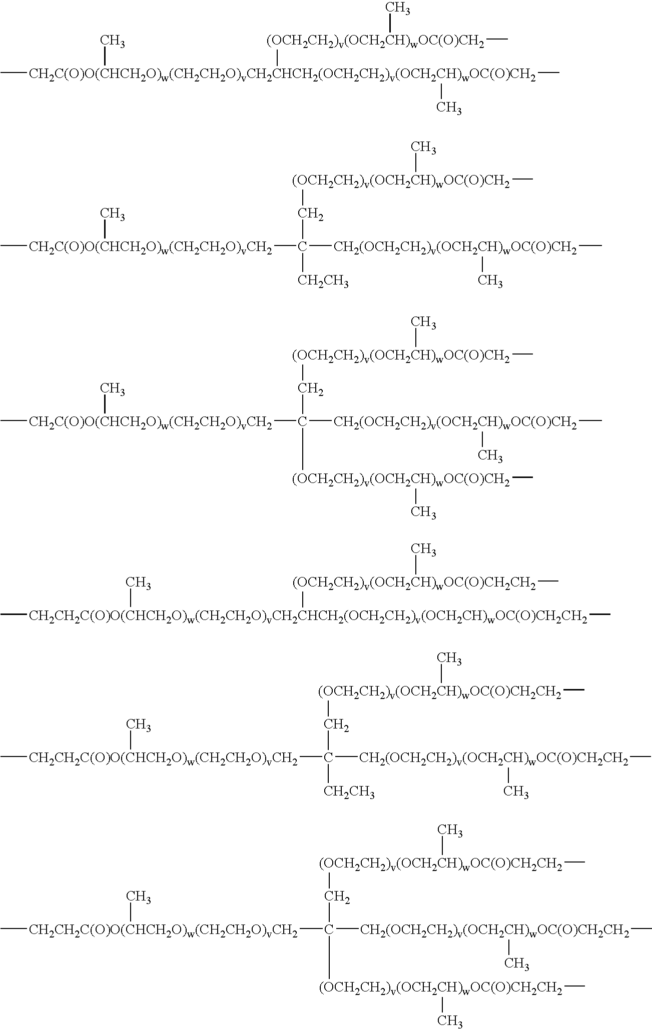

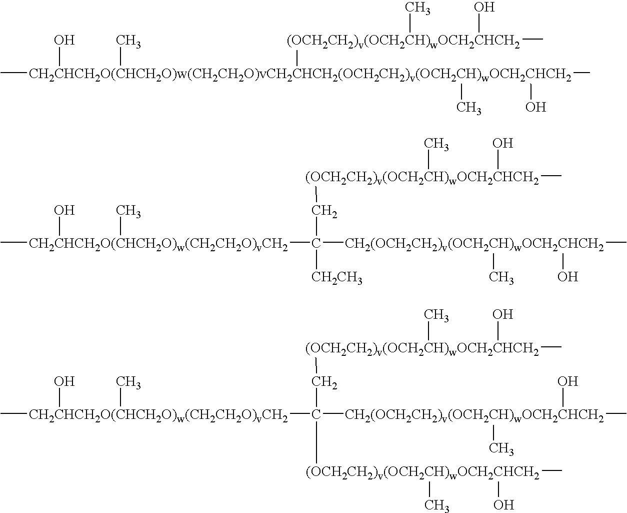

where v+w≧0, where the arrangement of the ethylene oxide and propylene oxide units may be random or blockwise and the attachment to Q may be via ethylene oxide and propylene oxide units via a carbon atom.

The branched unit V³ may contain a trivalent or higher-valency organopolysiloxane unit, for example:

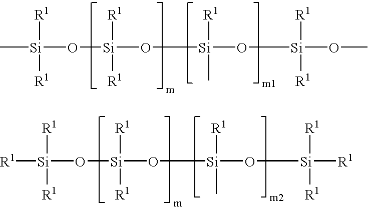

in which R¹ is as defined above, m=from 0 to 1000, and m¹≧1 and m²≧3,

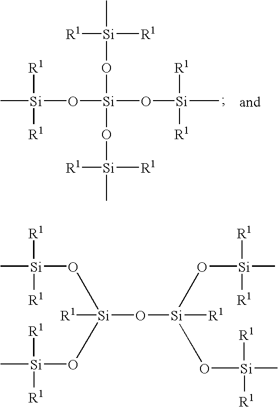

in which R¹ is in each case as defined above.

One example of a Z³-containing branch unit V³ is, for example:

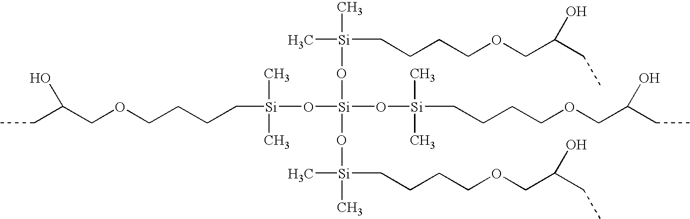

The polysiloxanes used in accordance with the invention may contain R^{O} units which may preferably be incorporated into the polymer by suitable alkylation reactions of primary, secondary or tertiary mono-amino-functionalized polyalkylene oxides with reactively functionalized siloxane precursors. Preference is given to using the mono-primary functionalized Jeffamine® of the M series (Huntsman Corp.).

In a preferred embodiment, the primary mono-amino-functionalized polyalkylene oxides are first alkylated in a preceding reaction with the reactively functionalized siloxanes, preferably epoxysiloxanes, to give tertiary amines. These precursors are incorporated into the siloxane block copolymer in the subsequent polymer formation reaction. In another preferred variant, it is possible to dispense with this preceding reaction and to use the primary mono-amino-functionalized polyalkylene oxides directly in the polymer formation reaction.

For the less preferred case that the polyalkylene oxide units are to terminate the siloxane block copolymers in a controlled manner, it is possible to proceed from secondary or tertiary amino-functionalized polyalkylene oxide units. When they are not available directly, they may be prepared by prereaction of the primary mono-amino-functionalized polyalkylene oxides with alkylating agents, for example monoepoxides such as isopropyl glycidyl ether or dimethyl sulfate.

The monofunctionally attached hydrophilic R^{O} element may be introduced into the polyquaternary polysiloxane copolymers used in accordance with the invention in order to enhance the hydrophilicity in a controlled manner. This leads both to enhanced hydrophilicity of the inventive polysiloxane copolymers themselves, such that, for example, facilitated transfer into the moist laundry proceeds, and to an increase in the hydrophilicity of the textiles treated with the inventive compositions, which leads, for example, to an improved moisture absorption of the textiles.

Examples of alternating polysiloxane quat block copolymers usable in accordance with the invention are, for example, described in DE-A 3340708, U.S. Pat. No. 6,240,929, EP 282720, DE-A 10036533, WO 02/10257, WO 02/10259, WO 03/078504, WO 2004/041912, WO 2004/042136 and the application PCT/EP 2004/050472.

The polyamino- and/or polyammonium-polysiloxane compounds used in accordance with the invention may be solid or liquid at 25° C. In the case that they are liquid at 25° C., the viscosities of the polysiloxanes mentioned are preferably between 500 to 50 000 000 mPa·s at 25° C., preferably from 1000 to 2 500 000 mPa·s at 25° C. and a shear rate of D=1 s⁻¹.

In the inventive composition, the substrate is generally a support material which is solid (at room temperature (25° C.) and preferably up to the decomposition temperature) and is capable of absorbing the polyamino- and/or polyammonium-polysiloxane compounds and especially of releasing them again under the conditions of laundry drying. The material is therefore preferably a porous material. The substrates may, for example, be present in layer form, in pouch form or in compact layers. It is also possible to use solid undeformable porous substrates such as granules, which may in turn be incorporated into cloths. More preferably, the substrate is present in the form of a layered material. Preference is given in accordance with the invention, for example, to spongelike or fibrous materials such as fiber wovens, fiber nonwovens, paper towels. With regard to the materials used, there are no particular restrictions provided that the substrate material can accommodate the polyamino- and/or polyammonium-polysiloxane compounds. Preferred materials are natural or synthetic fibers, such as those based on cellulose, such as cotton, and also wool, sisal, linen, cellulose esters, polyvinyl compounds, polyolefins, polyamides, polyurethanes, polyesters. Spongelike materials may, for example, consist of polyurethanes.

The inventive compositions contain appropriately from 0.01 to 20% by weight, preferably from 0.1 to 10% by weight, even more preferably from 0.3 to 5% by weight of the polyamino- and/or polyammonium-polysiloxane compounds, based on the total weight of the composition.

The inventive composition may further comprise at least one further textile treatment composition. Such textile treatment compositions include, for example: further softeners and antistats other than those used in accordance with the invention, bacteriostats, antifungal and antimoth compositions, deodorants, fragrances, ironing aids, anticrease agents, etc. These may be present in the inventive composition in amounts of up to 20% by weight.

Moreover, the inventive composition may comprise one or more solvents, such as water or alcohols.

The invention further relates to a process for preparing the inventive composition, which comprises the application of at least one polyamino- and/or polyammonium-polysiloxane compound to the substrate. The application can be effected in a manner known per se (see, for example, U.S. Pat. No. 3,442,692), for example by impregnation, spraying, etc., if appropriate with use of solvents. The invention also includes the case that the end consumer is provided with the polyamino- and/or polyammonium-polysiloxane compounds used in accordance with the invention, if appropriate in a mixture with further ingredients in liquid form, for application to a separately provided solid substrate, and the end consumer him- or herself produces the inventive composition by impregnating the solid substrate with the liquid composition provided immediately before use.

The invention further relates to a process for treatment of textiles, which includes the contacting of the inventive composition with the textiles. In this case, the inventive composition is preferably contacted with the still moist textiles originating from the textile washing operation, preferably at temperatures of more than 25° C., preferably using commercial laundry dryers. Accordingly, the invention further relates to the of use of the inventive composition for treatment of textiles composed of natural or synthetic fibers. The invention further relates to the use of polyamino- and/or polyammonium-polysiloxane copolymer compounds for producing solid textile treatment compositions, especially for producing substrate-based textile treatment compositions. As above, “solid” means here that the external application form essentially does not change during the application to the textiles, which is ensured especially by the use of a solid support as defined above. Preference is given to the above-described use of polyamino- and/or polyammonium-polysiloxane copolymer compounds in liquid form at room temperature, if appropriate with addition of further functional constituents such as those specified above, and solvents.

### EXAMPLES

### Example 1

### 1a) Synthesis of a Chloroacetic Ester

384 g (0.384 mol) of a commercially available polyethylene glycol PEG 1000 are initially charged at room temperature under nitrogen. The material is heated to 70° C. and melted in the course thereof. With intensive stirring, 104 g (0.92 mol) of chloroacetyl chloride are added dropwise within 15 minutes. During the dropwise addition, the temperature rises to 90° C. without heating, and HCl evolution sets in. After the dropwise addition has ended, the mixture is heated to 120° C. for 1.5 hours. Finally, all constituents which boil up to 120° C./5 hPa are distilled off. 424 g of a colorless wax are obtained, which has the composition, determined by ¹H NMR, of

ClCH₂C(O)O[CH₂CH₂O]₂₁OC(O)CH₂Cl.

The solids content is 99.7%.

### Example 1b)

### Synthesis of a Block Copolymer

In a 500 ml three-neck flask, under nitrogen, 100 g (17.27 mmol) of a siloxane epoxide of the structure

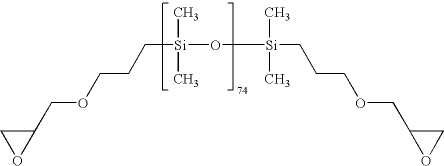

3.46 g (34.54 mmol) of N-methylpiperazine and 50 g of n-butanol are mixed with one another and heated to 100° C. for 6 hours.

19.61 g (17.27 mmol) of the ester according to example 1a, dissolved in 73 g of n-butanol, are added to the mixture, and the overall mixture is heated to 100-106° C. for a further 12 hours. Finally, the mixture is heated to 117° C. for 8 hours. A yellow biphasic product is obtained, which is converted to a viscous opaque mass in the course of shaking.

The solids content is 49.8% by weight. According to ¹H NMR data, the conversion of the epoxide at the end of the reaction is 95.1%, the conversion of the chloroacetic ester 93.9%. The polymer has the following structure:

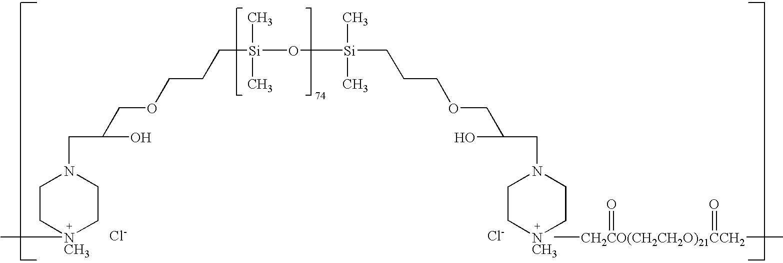

### Example 2

Wash tests are performed in a Miele Novotronic W526.

Wash conditions: 95° C., short wash cycle, 2× rinse, dosage of the fabric softener in the second rinse cycle, spin at 1200 rpm

Drying: line drying for 24 hours

| Wash test 1 (inventive) | Wash test 2 (not inventive) |
|---|---|
| Machine load: | Machine load: |
| 1782 g of terry fabric ballast material + 6 | 1782 g of terry fabric ballast |
| terry fabric cloths Σ 221 g | material + 6 |
| | terry fabric cloths Σ 221 g |
| Detergent: | Detergent: |
| 75 ml of Ariel Hydractive ® | 75 ml of Ariel Hydractive ® |
| Fabric softener mixture: | Fabric softener: |
| 8.75 g of Lenor ® (approx. 1.31 g of | 35 g of Lenor ® (approx. |
| active substance) | 5.25 g of active substance) |
| 4 g of the shaken quat solution | |
| according to | |
| 1b (2 g of Si quat) | |
| 13 g of deionized water | |

Ariel Hydractive®: trade name of Procter&Gamble GmbH
Lenor®: trade name of Procter&Gamble GmbH

### Hand Assessment

5 cloth pairs are formed, each consisting of one terry fabric cloth treated in accordance with the invention and one terry fabric cloth treated not in accordance with the invention. These cloth pairs are assessed with regard to hand by 4 test subjects. A total of 20 comparative hand assessments are made.

For the cloth with better hand in each case, a mark of from 1 to 4 is possible. The result of the assessment is that the cloths finished in accordance with the invention receive an overall mark of +0.58.

### Hydrophilicity

10 water droplets (50 μl) are placed onto one terry fabric cloth finished in accordance with the invention and one terry fabric cloth finished not in accordance with the invention, and the times taken for them to sink in are measured.

The droplets sink in on the cloths finished in accordance with the invention as soon as they are placed on.

The droplets sink in on the cloths finished not in accordance with the invention within an average of one second, and the sinking-in is visibly delayed with respect to the cloths finished in accordance with the invention.

### Overall Evaluation

The data show that, in spite of a reduction in the total amount of softener to 25% and an only partial replacement by the inventive siloxane block copolymers, an improvement in hand can be achieved. At the same time, the hydrophilicity of the finished textile material increases significantly.

1. A composition comprising a substrate and at least one polyamino- and/or polyammonium-polysiloxane compound which has been applied to the substrate.

2. The composition as claimed in claim 1, in which the polyamino- and/or polyammonium-polysiloxane compounds comprise at least one organopolysiloxane group and at least one amino and/or ammonium group.

3. The composition of claim 1, in which the polyamino- and/or polyammonium-polysiloxane compounds comprise at least two organopolysiloxane groups and at least two amino and/or ammonium groups.

4. The composition of claim 1, in which the polyamino- and/or polyammonium-polysiloxane compounds are selected from polyamino- and/or polyammonium-polysiloxane copolymer compounds which have linear molecule sections with alternating organopolysiloxane groups and amino and/or ammonium groups.

5. The composition of claim 1, in which the polyamino- and/or polyammonium-polysiloxane copolymer compounds have at least one repeat unit of the formula (I):
-[Q-V]— (I)
in which Q is selected from the group which consists of:
—NR—,
—N⁺R₂—,
a saturated or unsaturated diamino-functional heterocycle of the formulae: 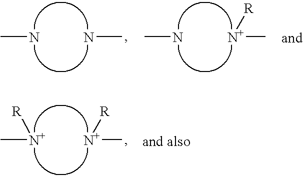
an aromatic diamino-functional heterocycle of the formula: 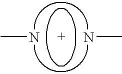
a trivalent radical of the formula: 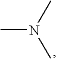
a trivalent radical of the formula: 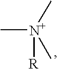
or
a tetravalent radical of the formula 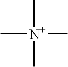
in which R is in each case hydrogen or a monovalent organic radical,
where Q is not bonded to a carbonyl carbon atom,
V is selected from the group which consists of V¹, V² and V³, in which
V² is selected from divalent straight-chain, cyclic or branched, saturated, unsaturated or aromatic hydrocarbon radicals which have up to 1000 carbon atoms (not counting the carbon atoms of the polysiloxane radical Z² defined below) and may optionally contain one or more groups selected from
—O—, —CONH—, 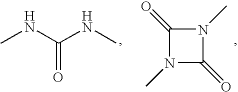
—CONR²— in which R² is hydrogen, a monovalent straight-chain, cyclic or branched, saturated, unsaturated or aromatic hydrocarbon radical which has up to 100 carbon atoms, may contain one or more groups selected from —O—, —NH—, —C(O)— and —C(S)— and may optionally be substituted by one or more substituents selected from the group which consists of a hydroxyl group, an optionally substituted heterocyclic group preferably containing one or more nitrogen atoms, amino, alkylamino, dialkylamino, ammonium, polyether radicals and polyether ester radicals, where, when a plurality of —CONR² groups are present, they may be the same or different,
—C(O)— and —C(S)—,
the V² radical may optionally be substituted by one or more hydroxyl groups and/or by
—Si(OR)₃₋ₐ(R′)ₐ
in which a is an integer from 0 to 2 and R and R′ may be the same or different and are each an organic radical, and
the V² radical contains at least one -Z²- group of the formula 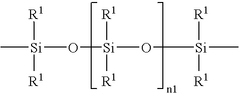
in which
R¹ may be the same or different and is selected from the group which consists of: C₁-C₂₂-alkyl, fluoro(C₁-C₁₀)alkyl, C₆-C₁₀-aryl and —W—Si(OR)₃₋ₐ(R′)_{a in which R, R}¹ and a are each as defined above and W is —O— or a divalent straight-chain, cyclic or branched, saturated, unsaturated or aromatic hydrocarbon radical which has up to 100 carbon atoms, may contain one or more —C(O)—, —O—, —NH—, —S— groups and may optionally be substituted by hydroxyl groups, and
n₁=from 20 to 1000,
V¹ is selected from divalent straight-chain, cyclic or branched, saturated, unsaturated or aromatic hydrocarbon radicals which have up to 1000 carbon atoms and may optionally contain one or more groups selected from 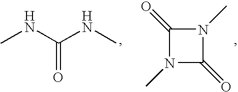
—O—, —CONH—,
—CONR²— in which R² is as defined above, where the R² groups in the V¹ and V² groups may be the same or different,
—C(O)—, —C(S)— and -Z¹- in which -Z¹- is a group of the formula 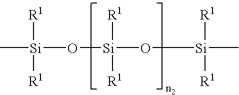
in which
R¹ is as defined above, where the R¹ groups in the V¹ and V² groups may be the same or different, and
n₂=from 0 to 19,
and the V¹ radical may optionally be substituted by one or more hydroxyl groups and/or by
—Si(OR)₃₋ₐ(R′)ₐ
in which a is an integer from 0 to 2 and R and R′ may be the same or different and are each an organic radical, and
V³ is a trivalent or higher-valency straight-chain, cyclic or branched, saturated, unsaturated or aromatic hydrocarbon radical which has up to 1000 carbon atoms and may optionally contain one or more groups selected from
—O—, —CONH—, 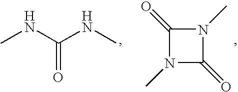
—CONR²— in which R² is as defined above, —C(O)—, —C(S)—, -Z¹- which is as defined above, Z² which is as defined above, and Z³ in which Z³ is a trivalent or higher-valency organopolysiloxane unit, and
which may optionally be substituted by one or more hydroxyl groups and/or by
—Si(OR)₃₋ₐ(R′)ₐ
in which a is an integer from 0 to 2 and R and R′ may be the same or different and are each an organic radical,
with the proviso
that the polysiloxane compound mentioned contains at least one -Z¹-, -Z²- or Z³ group,
that the trivalent and tetravalent Q radicals either serve to branch the main chain formed from Q and V, such that the valencies which do not serve for bonding in the main chain bear further branches formed from -[Q-V]— units, or the trivalent and tetravalent Q radicals are saturated by V³ radicals within a linear main chain without formation of a branch, and
in which the positive charges which result from ammonium groups are neutralized by organic or inorganic acid anions.

6. The composition as claimed in claim 5, characterized in that V comprises repeat units of the formulae V¹ and V².

7. The composition of claim 1, in which the substrate is a solid support material which is capable of incorporating the polyamino- and/or polyammonium-polysiloxane compounds and of releasing them again.

8. The composition of claim 1, in which the substrate is a porous material.

9. The composition of claim 1, in which the substrate is a spongelike or fibrous material.

10. The composition of claim 1, in which the composition includes from 0.01 to 20% by weight of the polyamino- and/or polyammonium-polysiloxane compounds, based on the total weight of the composition.

11. The composition as of claim 1, further comprising a textile treatment composition.

12. A process for preparing the composition of claim 1, which comprises the application of at least one polyamino- and/or polyammonium-polysiloxane compound to a substrate.

13. A process for treatment of textiles, which includes the contacting of the composition of claim 1 with the textiles.

14. The process of claim 13, comprising contacting the composition with moist textiles, if appropriate at temperatures of more than 25° C.

15. The use of the composition of claim 1 for treatment of textiles.

16. Use of polyamino- and/or polyammonium-polysiloxane copolymer compounds for producing solid textile treatment compositions.

17. The composition of claim 5, wherein the substrate is a solid support material which is capable of releasably binding the polyamino- and/or polyammonium-polysiloxane compounds.

18. The composition of claim 5, wherein the substrate is a porous material.

19. The composition of claim 5, wherein the substrate is a spongelike or fibrous material.

20. The composition of claim 5, wherein the composition includes from 0.01 to 20% by weight of the polyamino- and/or polyammonium-polysiloxane compounds, based on the total weight of the composition.
